(19) United States
(12) Patent Application Publication
(10) Pub. No.: US 2015/0012498 A1
(43) Pub. Date: Jan. 8, 2015

(54) CREATING AN ARCHIVAL MODEL

(71) Applicants: Danny Oberoi, Bangalore (IN); Tina Dasgupta, Bangalore (IN); Arunkumar Sreedharan, Bangalore (IN)

(72) Inventors: Danny Oberoi, Bangalore (IN); Tina Dasgupta, Bangalore (IN); Arunkumar Sreedharan, Bangalore (IN)

(21) Appl. No.: 14/375,486

(22) PCT Filed: Apr. 9, 2012
(86) PCT No.: PCT/US2012/032723

§ 371 Date: Jul. 30, 2014

(51) Int. Cl. G06F 17/30

(52) U.S. Cl. CPC G06F 17/30339; G06F 17/30321; G06F 17/30595
USPC 707/667

(57) ABSTRACT

At least one relationship among a plurality of data storage tables in a data repository is determined. An archival model is created based on the determined at least one relationship, where the archival model is useable to archive content of the data storage tables.

### BACKGROUND

A data repository (e.g. a database of a relational database management system) can be used to store data in various data storage tables. Over time, the amount of information stored in the data storage tables can grow. As data storage tables grow in size, performance relating to access of the content of the database tables may suffer. Also, costs associated with maintaining such growing database tables can also increase.

### BRIEF DESCRIPTION OF THE DRAWINGS

Some embodiments are described with respect to the following figures:

FIG. 1 is a block diagram of an example arrangement that includes an archival model creation subsystem according to some implementations;

FIGS. 2 and 3 are flow diagrams of processes for building an archival model, according to various implementations; and

FIG. 4 is a block diagram of an example computing system that incorporates some implementations.

### DETAILED DESCRIPTION

Data storage tables in a data repository can store various data. In some implementations, the data repository is a database that is part of a relational database management system, and the data storage tables can be database tables. A database table, also referred to as a relation, stores data in tuples (also referred to as “rows”), where a tuple can include values for multiple attributes (also referred to as “columns”). More generally, a “data storage table” can refer to any data structure that is used to store data in a predefined arrangement that allows selected data to be retrieved in response to a query.

As the data storage tables in a data repository grow in size, performance associated with accessing the content of the data storage tables can suffer. For example, a query that seeks to access a data storage table may involve a scan of the content of the data storage table. The time involved in scanning a data storage table is proportional to its size; thus, it may take a longer time to scan a larger data storage table than a smaller data storage table. Another type of operation that can be performed with respect to data storage tables is a join operation, in which content of two or more data storage tables are combined into an output, where the output includes selected attributes from the two or more data storage tables that satisfy certain predicates specified in a join query. The time involved in joining multiple data storage tables can be proportional to the sizes of the data storage tables.

A system can also perform certain maintenance operations with respect to data storage tables. For example, an index can be defined on the data storage table, where the index correlates values of a given attribute (or attributes) to respective identifiers of entries (e.g. rows) of the data storage table. The index is sorted according to the values of the given attribute(s), such that the result for a query seeking entries of the data storage table containing specific value(s) of the given attribute(s) can more quickly be obtained using the index (as opposed to having to scan the data storage table to find the target entries). The index is updated as the data storage table is updated—the cost (time, processing resource, etc.) associated with updating the index is proportional to the size of the respective data storage table.

Other types of maintenance operations can be performed with respect to data storage tables, and the costs of such maintenance operations can be proportional to the sizes of the data storage tables.

Archiving a portion of data in data storage tables can alleviate the issue of slower performance and increased maintenance costs due to the sizes of the data storage tables. Archiving content of a data storage table refers to moving a portion of the data storage table that satisfies some criterion or criteria (e.g. the archived content is older than some predefined age, the archived content includes data from a particular customer or from a particular department of an enterprise, etc.) to an archive repository. The archived portion of the data storage table is removed from the data storage table, such that the data storage table becomes smaller after the archiving.

Because data storage tables of a data repository may be related to one another, the archiving of the data storage tables should consider the relationship between the data storage tables (in other words, the archiving of the content of the related data storage tables should not be performed individually without considering the relationship among the two or more data storage tables). For example, if there is a relationship between a first data storage table and a second data storage table, then the data archiving should include archival of the content of the first and second data storage tables.

Relationships among tables can include a direct relationship or an indirect relationship. For example, an attribute of a first table can be directly related to an attribute of a second table. As a further example, an attribute of a third table can be directly related to the attribute of the second table—in this case, the attribute of the third table is indirectly related to the attribute of the first table.

Understanding the relationships among data storage tables (particularly in a data repository having a relatively large number of data storage tables) can be a complex and time-consuming process if performed manually by user(s). In accordance with some implementations, to archive content of data storage tables of a data repository, an automated mechanism is provided to determine relationships among the data storage tables. Once relationship(s) among data storage tables is determined, such relationship(s) can be used to develop an archival model. The archival model contains information that specifies the relationship(s) of multiple data storage tables that are to be archived. A data management subsystem can use the archival model to archive content of the related storage tables specified in the archival model.

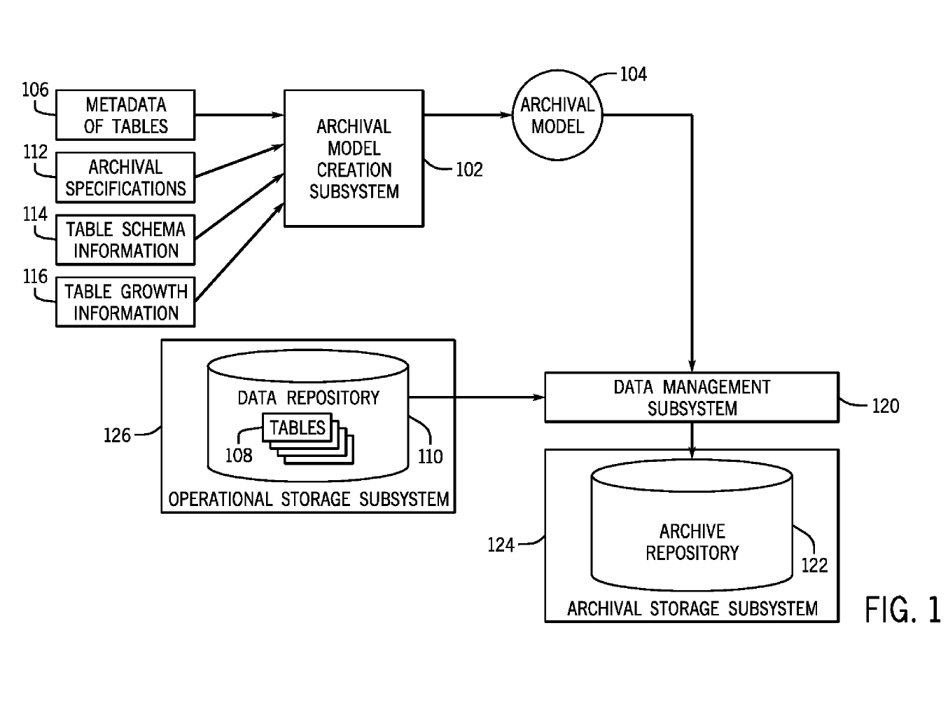

FIG. 1 is a block diagram of an example system according to some implementations. The system includes an archival model creation subsystem 102 that is able to create, in an automated manner, an archival model 104 based on various input information. The input information includes metadata 106 of data storage tables 108 in a data repository 110. The metadata 106 describes various information of the data storage tables 108, including any relationships among the tables. As discussed further below, the metadata 106 can be in the form of temporary tables that can be queried to determine relationships among various data storage tables 108. In other examples, the metadata 106 can be stored in other data structures.

Although just one data repository 110 is depicted in FIG. 1, note that there can be multiple data repositories containing respective sets of data storage tables that are to be archived.

Further input information that can be provided to the archival model creation subsystem 102 includes archival specifications 112, which specify various rules associated with archiving data of the data repository 110. For example, the archival specifications 112 can specify that data older than some predefined age is to be archived. As other examples, the archival specifications 112 can specify that data associated with customer orders that have been closed (e.g. products ordered by customers have been shipped and customers have made payment) should be archived. As further examples, the archival specifications 112 can specify that data from a particular source (e.g. particular group of customers, particular department of an enterprise, etc.) should be archived. The archival specifications 112 can be used by the archival model creation subsystem 102 to identify data storage tables that contain content (satisfying the archival specifications 112) that are to be archived.

Further input information to the archival model creation subsystem 102 includes table schema information 114. The table schema information 114 describes the definition (e.g. set of attributes) of each of the data storage tables. The table schema information 114 allows the archival model creation subsystem 102 to identify the collection of tables 108 that are in the data repository 110.

Further input information to the archival model creation subsystem 102 includes table growth information 116. In some examples, the table growth information 116 can identify a rate of growth for each of the data storage tables 108 in the data repository 110. Since archiving all of the data storage tables 108 in the data repository 110 can be processing intensive, the table growth information 116 can be used by the archival model creation subsystem 102 to identify a subset of the data storage tables 108 that are to be archived (the data storage tables 108 not in the identified subset are not archived). For example, a data storage table that is a candidate for archiving can be a table whose rate of growth exceeds some predefined growth threshold (e.g. the table is growing at greater than X rows per hour).

In other examples, instead of table growth information (or in addition to the table growth information), size information regarding the tables 108 can also be used by the archival model creation subsystem 102 to identify tables that are to be archived. The size information can indicate the size of a data storage table, such as in terms of a number of rows in the table, or the storage space consumed by the table. If the size information of the data storage table indicates that the table has a size greater than some predefined threshold, then the archival model creation subsystem 102 can identify the table as a table whose content is to be archived. More generally, the identification of a subset of the data storage tables 108 for archiving can be based on a size criterion, which can either be a criterion relating to rate of growth, or a criterion relating to table size.

Based on the various input information depicted in FIG. 1, the archival model creation subsystem 102 according to some implementations creates an archival model 104. The archival model 104 can be represented in graphical form—for example, the archival model 104 can be represented as a graph having nodes, which represent corresponding data storage tables, and links between the nodes, which represent corresponding relationships between pairs of data storage tables. In other examples, the archival model 104 can be represented in another format, such as in text form (e.g. text in a markup language document such as an eXtensible Markup Language or XML document), or in any other predefined format.

The archival model 104 can be provided to a data management subsystem 120. In some examples, the data management subsystem 120 can be a database management subsystem which includes a database management application that is able to manage access of tables 108 of the data repository 110. In other examples, the data management subsystem 120 can be an archival subsystem. Using the archival model 104, the data management system 120 is able to archive content of data storage tables to an archive repository 122.

The archive repository 122 can be stored in an archival storage subsystem 124 that is separate from an operational storage subsystem 126 used to store the data repository 110. In some examples, the storage device(s) of the archival storage subsystem 124 can be lower performance storage device(s) that is (are) less costly than the storage device(s) of the operational storage subsystem 126. Examples of the storage devices of the archival and operational storage subsystems 124 and 126 can include disk-based storage devices, tape-based storage devices, semiconductor storage devices, or other types of storage devices.

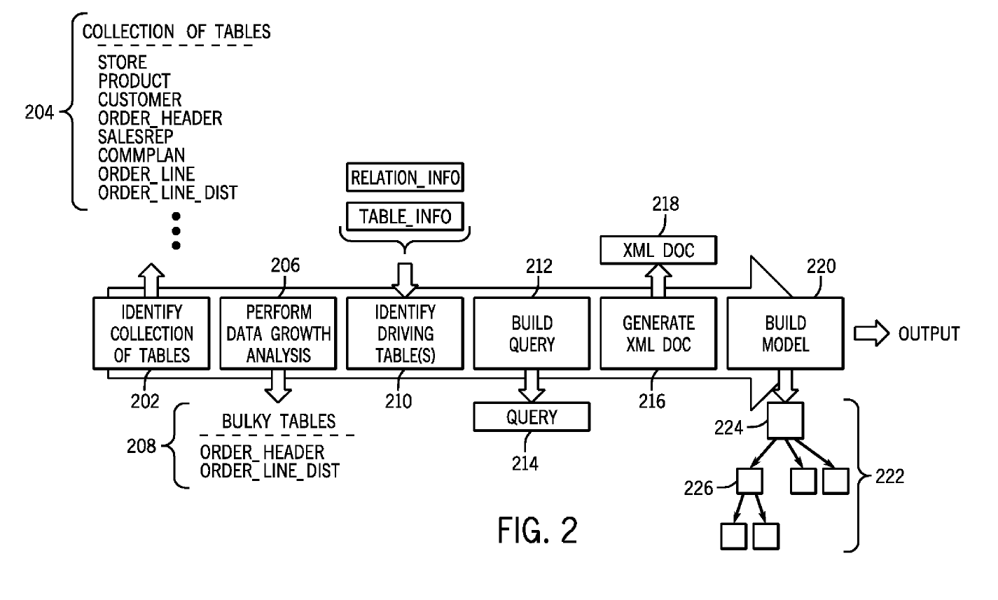

FIG. 2 is a flow diagram of a process according to some implementations. The flow diagram of FIG. 2 can be performed by the archival model creation subsystem 102, for example. The process of FIG. 2 identifies (at 202) a collection of data storage tables 108 in the data repository 110. This identifying can be based on the table schema information 114 of FIG. 1, for example. An example collection 204 of data storage tables is depicted in FIG. 2.

As noted above, it may not be desirable to archive the content of all of the data storage tables 108 in the data repository 110. In some implementations, data growth analysis is performed (at 206), to identify the data growth of each of the data storage tables in the collection 204. The data storage tables whose data growth (based on the table growth information 116) exceeds a predefined growth rate threshold are identified, and output as identified “bulky tables” (e.g. 208 in FIG. 2). A “bulky table” can refer to a data storage table whose data growth exceeds a predefined growth rate threshold. Alternatively or additionally, a “bulky table” can refer to a data storage table whose size exceeds a predefined size threshold. In the example of FIG. 2, the identified bulky tables include an ORDER_HEADER table and an ORDER_LINE_DIST table.

The process next identifies (at 210) one or multiple driving tables. A “driving table” refers to a parent table whose content is to be archived along with content of dependent tables that are related to the parent table. In the example of FIG. 2, the ORDER_HEADER table can be identified as a driving table. Whether or not a bulky table is identified as a driving table can be based on a predefined criterion or criteria. In some implementations, a criterion can be that the bulky table identified as the driving table is a base data storage table that is related to other data storage tables, such as in a given transaction (e.g. join transaction) in a relational database management system. To produce a result of a join transaction, for example, content (attribute or attributes) of the base data storage table is compared with content (attribute or attributes) of other data storage tables according to a predicate (condition) specified in a join query, and rows of the base data storage table and other data storage tables are selected for output if the predicate (condition) is satisfied. The output of the join transaction is thus based on content of the base data storage table and other data storage tables related to the base data storage table.

The foregoing is an example of a relationship among tables that is based on a given transaction of a relational database management system. In other examples, a relationship among tables can also be based on a primary key-foreign key relationship. A primary key includes an attribute (or attributes) of a first data storage table, and a foreign key includes an attribute (or attributes) of a second data storage table. The foreign key in the second data storage table matches the primary key in the first data storage table, such that the pair of the primary key and foreign key can be used to cross-reference the first and second data storage tables. More formally, a foreign key provides a referential constraint between data storage tables. There can be multiple data storage tables that include respective foreign keys that are related to the primary key of the first data storage table.

To determine the relationship(s) of other table(s) to the driving table (e.g. ORDER_HEADER in the example of FIG. 2), the metadata 106 of FIG. 1 can be accessed. The metadata 106 can include temporary tables that can be queried by the archival model creation subsystem 102 for identifying relationships among tables. For example, in FIG. 2, the temporary tables include a temporary RELATION_INFO table and a temporary TABLE_INFO table.

In specific examples, the temporary TABLE_INFO table contains various rows that include the following attributes (there can possibly be other attributes as well): ID (identifier), NAME, and TYPE.

TABLE_INFO

| ID | NAME | TYPE |
|---|---|---|
| 1 | ORDER_HEADER | T |
| 2 | STORE | L |
| 3 | STATUS | L |
| . . . | . . . | . . . |
| 12 | ORDER_LINE | T |
| 13 | ORDER_LINE_DIST | T |

The ID attribute contains an identifier of a corresponding table specified by the NAME attribute. For example, the ORDER_HEADER table (included in the first row of TABLE_INFO) has an identifier of 1. The TYPE attribute specifies the type of the table, which can be a transaction table (indicated by “T”) or a lookup table (indicated by “L”). In some examples, transaction tables are archived but lookup tables are not archived. In other examples, tables can have other or additional types.

In specific examples, the temporary RELATION_INFO table contains the following attributes (there can possibly be other attributes as well): REL_ID, TN_ID, COL_PARENT, COL_CHILD.

RELATION_INFO

| REL_ID | TN_ID | COL_PARENT | COL_CHILD |
|---|---|---|---|
| 1 | 12 | ORDERID | ORDERID |
| 1 | 6 | CUSTOMERID | CUSTOMERID |
| 12 | 13 | ORDERLINEID | ORDERLINEID |
| . . . | . . . | . . . | . . . |

The REL_ID attribute and TN_ID attribute in RELATION_INFO identify the related tables (ID 1 corresponds to the ORDER_HEADER table, ID 12 corresponds to the ORDER_LINE table, and ID 13 corresponds to the ORDER_LINE_DIST tables, as indicated in the example temporary TABLE_INFO table). Thus, in the example RELATION_INFO table above, the first row indicates that data storage tables having IDs 1 and 12 (ORDER_HEADER and ORDER_LINE, respectively) are related based on the attribute ORDERID in the related tables (specified by the COL_PARENT and COL_CHILD attributes). For example, the COL_PARENT attribute in RELATION_INFO can identify the primary key (ORDERID) in the ORDER HEADER table, while the COL CHILD attribute in RELATION INFO can identify the foreign key (ORDERID) in the ORDER_LINE table.

More generally, each row of the temporary RELATION_INFO table identifies the related data storage tables, and further identifies the columns in these data storage tables that are related (e.g. primary key-foreign key relationship, or relationship based on a join transaction).

Once the relationships among the data storage tables, including the driving table (e.g. ORDER_HEADER in FIG. 2) are determined, the process of FIG. 2 can use the relationships to produce various outputs. The determined relationships can be used to build (at 212) a query (214), where the query corresponds to a transaction that involves the various attributes of the related data storage tables. For example, the query can be a SQL (Structured Query Language) SELECT query, which can specify attributes from selected data storage tables that are to be used for joining the data storage tables. Such a SELECT query can be used by a user for various purposes, such as to easily ascertain the relationship among tables.

The process of FIG. 2 can also generate (at 216) a text-based document, such as an XML document 218, which describes the relationships among the data storage tables, including the driving table and the related tables that are directly or indirectly related to the driving table. Additionally, the process of FIG. 2 can generate (at 220) a graph-based archival model 222, which can be in the form of a graph of nodes (that represent respective data storage tables) and links that identify relationships between pairs of data storage tables. In the graph representing the archival model 222, the root node 224 can represent the driving table (e.g. ORDER_HEADER in FIG. 2), and the nodes below the root node 224 are children nodes representing data storage tables that have a direct relationship to the driving table. In addition, child node 226 itself has further children nodes that represent data storage tables that are directly related to the data storage table represented by the child node 226.

The process can output the query 214, XML document 218, and the graph-based archival model 222 for subsequent use.

Note that some of the tasks depicted in FIG. 2 can be omitted in alternative implementations. For example, generation of the query 214 can be omitted. Additionally, just one of the XML document 218 or the graph-based archival model 222 can be generated, with either used as an archival model by the data management subsystem 120 of FIG. 1 for performing data archiving.

In response to an event triggering data archiving (e.g. a time event indicating that some predefined amount of time has passed since the last data archival operation, an event corresponding to a request from a user or application, etc.), the data management subsystem 120 uses the archival model to perform a data archival operation. The data management subsystem 120 can evaluate rules in archival specifications to ascertain data to be archived (e.g. data older than some predefined age, data associated with closed customer orders, etc.). The archival model is used by the data management subsystem 120 to determine content of related tables that are to be archived together. The rules of the archival specifications can be evaluated against the content in the related tables to identify the content to be archived. The identified content to be archived can then be copied to the archive repository 122 (FIG. 1). Once the archival operation is ready to complete, a commit operation can be performed to commit the movement of the archived data from the data storage tables in the data repository (110 in FIG. 1) to the archive repository 122.

FIG. 3 is a flow diagram of a process according to alternative implementations. The process of FIG. 3 determines (at 302) at least one relationship among multiple (two or more) data storage tables (e.g. 108 in FIG. 1) in a data repository. According to the determined at least one relationship, the process creates (at 304) an archival model (e.g. 104 in FIG. 1), where the archival model is useable to archive content of the data storage tables.

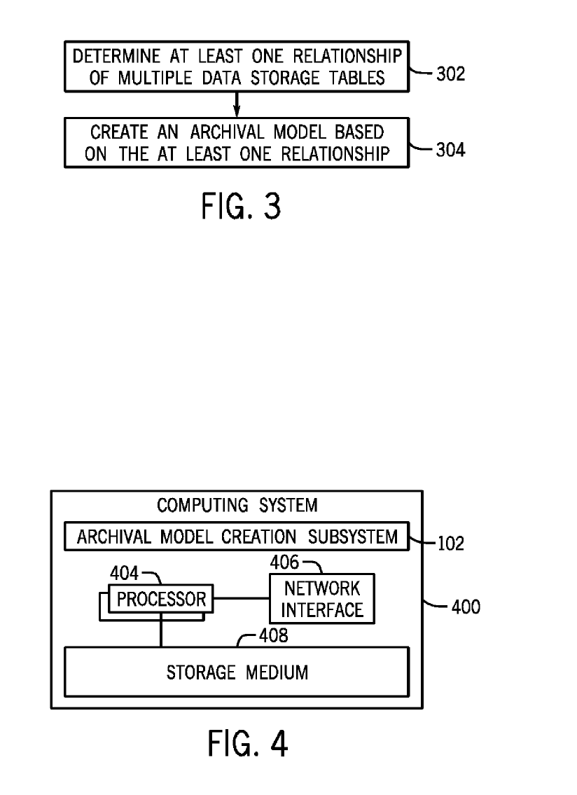

FIG. 4 is a block diagram of an example computing system 400 that incorporates some implementations. The computing system 400 can include the archival model creation subsystem 102 of FIG. 1. Although not shown in FIG. 4, the computing system 400 can also include the data management subsystem 120 of FIG. 1; alternatively, the data management subsystem 120 of FIG. 1 is separate from the computing system 400.

The archival model creation subsystem 102 can be implemented as machine-readable instructions executable on one or multiple processors 404 (which can be provided in a computer node or in multiple computer nodes). The processor(s) 404 can be connected to a network interface 406 (to allow the computing system 400 to communicate over a data network) and to a storage medium (storage media) 408. A processor can include a microprocessor, microcontroller, processor module or subsystem, programmable integrated circuit, programmable gate array, or another control or computing device.

The storage medium (storage media) 408 can be used to store the various input information 106, 112, 114, and 116 depicted in FIG. 1. In some examples, the data repository 110 can also be stored in the storage medium (storage media) 408. Alternatively, the data repository 110 can be stored on separate storage medium (storage media) 408.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
determining, by a system having a processor, at least one relationship among a plurality of data storage tables in a data repository; and
creating, by the system, an archival model based on the determined at least one relationship, wherein the archival model is useable to archive content of the data storage tables.

2. The method of claim 1, further comprising:
providing the archival model to a data management subsystem to perform archiving of the content of the data storage tables.

3. The method of claim 1, wherein determining the at least one relationship comprises determining at least one relationship corresponding to a transaction involving the plurality of data storage tables.

4. The method of claim 1, wherein determining the at least one relationship comprises determining a primary key-foreign key relationship of the plurality of data storage tables.

5. The method of claim 1, further comprising:
identifying, from among a collection of data storage tables, a particular data storage table that is to be a subject of archiving, wherein the particular data storage table is part of the plurality of data storage tables.

6. The method of claim 5, wherein identifying the particular data storage table from among the collection of data storage tables is based on a size criterion.

7. The method of claim 6, wherein the identifying based on the size criterion comprises identifying based on a criterion relating to rates of growth of the data storage tables in the collection.

8. The method of claim 1, further comprising:
using, by a data management subsystem, the archival model to archive content of the data storage tables.

9. The method of claim 1, further comprising:
evaluating at least one rule relating to archiving against the data storage tables associated with the archival model to identify content of the data storage tables to archive.

10. An article comprising at least one machine-readable storage medium storing instructions that upon execution cause a system to:
determine rates of growth of a plurality of data storage tables;
identify, based on the rates of growth, a particular one of the plurality of data storage tables that is a subject of archiving;
determine at least one relationship among the particular data storage table and at least one other data storage table; and
create an archival model based on the determined at least one relationship, wherein the archival model is useable to archive content of the particular data storage table and the at least one other data storage table.

11. The article of claim 10, wherein creating the archival model comprises creating a graph-based archival model.

12. The article of claim 10, wherein creating the archival model comprises creating a text-based archival model.

13. The article of claim 10, wherein identifying the at least one relationship is based on metadata relating attributes of the particular data storage table and the at least one other table.

14. The article of claim 10, wherein the instructions upon execution cause the system to further:
output the archival model to a data management subsystem to use in archiving content of the particular data storage table and the at least one other data storage table.

15. A system comprising:
at least one processor to:
determine at least one relationship among a plurality of data storage tables in a data repository; and
create an archival model based on the determined at least one relationship, wherein the archival model is useable to archive content of the data storage tables.
